(19) United States
(12) Patent Application Publication
(10) Pub. No.: US 2019/0384873 A1
(43) Pub. Date: Dec. 19, 2019

(54) SYSTEM AND METHOD FOR ESTIMATING A NUMBER OF ELECTRONIC THERMOSTATS IN AN AREA

(71) Applicants: 3R VALO, LIMITED PARTNERSHIP, Montreal (CA); HYDRO QUEBEC, Montreal (CA)

(72) Inventors: NILSON FERNANDO HENAO, TROIS-RIVIERES (CA); KODJO MAWUPE AGBOSSOU, TROIS-RIVIERES (CA); SOUSSO KELOUWANI, TROIS-RIVIERES (CA); MICHAEL FOURNIER, TROIS-RIVIERES (CA)

(73) Assignees: 3R VALO, LIMITED PARTNERSHIP, MONTREAL (CA); HYDRO QUEBEC, MONTREAL (CA)

(21) Appl. No.: 16/441,104

(22) Filed: Jun. 14, 2019

Related U.S. Application Data
(60) Provisional application No. 62/686,946, filed on Jun. 19, 2018.

(51) Int. Cl. G06F 17/50; G06F 17/14

(52) U.S. Cl. CPC G06F 17/5009; G06F 2217/16; G06F 17/141

(57) ABSTRACT

The present system and method allow non-intrusive estimation of a number of electronic thermostats in an area, where each electronic thermostat controls at least one thermal load. The system comprises a power sampler, an analog/digital converter and a processing unit. The power sampler collects, at one electric entry for the area, a finite sequence of samples of aggregated electric power consumed by the area. The analog/digital converter converts the samples of aggregated electric power into discrete-time samples. The processing unit converts the finite sequence of discrete-time samples of aggregated electric power into a discrete-frequency representation using a Discrete Fourier Transform (DFT) to identify dominant frequency components and analyze the dominant frequency components to estimate a commutating frequency of the electronic thermostats. The processing unit also receives the discrete-time samples and detects events based on the comparison between the power magnitude variation and a defined power threshold. The processing unit further estimates the number of electronic thermostats in the area based on the most likely estimated commutation frequency and the number of events found in the finite sequence of samples of aggregated electric power.

### TECHNICAL FIELD

The present disclosure relates to the field of non-intrusive analysis of aggregated electric power, and more particularly to a non-intrusive system and method for estimating a number of electronic thermostats in an area.

### BACKGROUND

In cold-climate region, space heating is an important part of the overall residential electricity consumption. Estimating the portion of the energy that is directed to thermal zones of a residential building is of primordial interest for thermal performance evaluation and for heating anomalies detection.

U.S. Pat. No. 8,660,813 and US Publication 20140324240 are prior art examples of estimations of electric consumption directed to heating elements in a residential building. This method is based on inverse modeling approach, which considers some environmental variables such as indoor and outdoor temperatures. However, there are other environmental and human factors, which can introduce considerable uncertainties in the estimation of heating energy demanded by thermal zones. Some of those factors are the thermal contribution of household loads as well as environmental and human heat.

Another prior art approach consists of installing sensors and dedicated hardware for gathering data about individual power consumption of thermal loads. This approach can provide more accurate results, nevertheless, the use of such devices is expensive and highly intrusive, and thus of very little interest for residential clients, as explained in January 2012 edition of Sensors titled “Non-intrusive load monitoring approaches for disaggregate energy sensing: a survey”.

Also known in the art is a method called Non-Intrusive Load Monitoring (NILM), which uses algorithms for detecting and disaggregating the individual power profiles by analyzing the overall electric consumption directly at an electric meter. Accordingly, this technique can be applied to estimate the power consumption related to heating loads. Detection of the electric consumption directed to heating loads requires recognition of corresponding electric signatures of targeted loads from aggregated measurements. Disaggregation in turn requires the estimation of power consumption of each load from aggregated power curves, as taught in U.S. Pat. No. 4,858,141. NILM provides valuable information when used in building relying on a central heating system, or a building having a single room where the heating elements are controlled by a single thermostat.

However, most homes in North America include one or several electric baseboards per room, and each room has its own thermostat. To add to the complexity, in most recent constructions, contractors typically install one electronic thermostat per room, where all electronic thermostats have identical electric signatures, thereby rendering estimation of the number of rooms or electric consumption per room is impossible.

There is therefore a need for a new method and system for non-intrusively estimating the number of electronic thermostats in an area.

### SUMMARY

According to a first aspect, the present disclosure relates to a system for non-intrusively estimating a number of electronic thermostats in an area, where each electronic thermostat controls at least one thermal load. The system comprises a power sampler, an analog/digital converter and a processing unit. The power sampler collects, at an electric entry of the area, a finite sequence of discrete samples of aggregated electric power consumed by the area. The analog/digital converter converts the finite sequence of discrete samples of aggregated electric power into discrete-time samples. The processing unit converts the discrete-time samples using a Discrete Fourier Transform (DFT) to obtain a discrete-frequency representation, to identify dominant frequency components and analyze the dominant frequency components of the discrete-frequency representation and to identify a commutating frequency of the electronic thermostats. The processing unit also receives the discrete-time samples and counts a number of power variations above a threshold in the discrete-time samples. The processing unit further estimates the number of electronic thermostats in the area based on the number of power variations above the threshold, a time period for collecting the discrete samples of aggregated electric power, and the extracted commutating frequency of the electronic thermostats.

According to a second aspect, the present disclosure relates to a method for non-intrusively estimating a number of electronic thermostats in an area, where each electronic thermostat controls at least one thermal load. The method comprises: collecting, by a power sampler connected at an electric entry of the area, a finite sequence of discrete samples of aggregated electric power consumed by the area. The method further comprises converting, by an analog/digital converter, the finite sequence of discrete samples of aggregated electric power into discrete-time samples. The method also counts by means of a processing unit, a number of power variations above a threshold in the finite sequence of discrete-time samples. The method also converts, by the processing unit, the discrete-time samples using a Discrete Fourier Transform into a discrete-frequency representation. The method further identifies, by the processing unit, dominant frequency components of the discrete-frequency representation, and analyzes, by the processing unit, the dominant frequency components to identify a commutating frequency of the electronic thermostats. The method also estimates, by the processing unit, the number of electronic thermostats in the area based on the number of power variations above the threshold in the discrete-time samples, a time period for collecting the discrete samples of aggregated electric power, and the extracted commutating frequency of the electronic thermostats.

### BRIEF DESCRIPTION OF THE DRAWINGS

Embodiments of the disclosure will be described by way of example only with reference to the accompanying drawings, in which:

FIG. 1A is a simplified block diagram of an area with a system for non-intrusively estimating a number of electronic thermostats in an area;

FIG. 1B is a simplified block diagram of the area with another example of system for non-intrusively estimating a number of electronic thermostats in the area;

FIG. 1C is a simplified block diagram of the area with yet another example of system for non-intrusively estimating a number of electronic thermostats in the area;

FIG. 2 is a functional block diagram of the present method and system for non-intrusively estimating a number of electronic thermostats in an area;

FIG. 3 is a graph showing the probability of observing an event as a function of the number of electronic thermostats in the area 1.

FIG. 4 is a graph showing the Fast Fourier transformation for one sample of aggregated electric power consumed showing dominant frequency components;

FIG. 5 is a block diagram of the system for non-intrusively estimating the number of electronic thermostats in the area;

FIG. 6 is a flow diagram of a method for non-intrusively estimating the number of electronic thermostats in the area; and

FIG. 7 shows two graphs resulting from an experiment performed to validate the present system and method, the upper graph depicting variations of events probability 206 over time and the lower graph shows a number of electronic thermostats in operation over the same period of time.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address a non-intrusive system and a method for estimating a number of electronic thermostats in an area.

The following terminology is used throughout the present disclosure:

Area: interior volume in which thermal loads are electrically powered to control comfort therein, the area may correspond to any type of residential, commercial or industrial building.

Electric entry: an entry point for electricity consumed by an area, the electric entry may be inside the area or outside the area, the electric entry may be connected directly to a utility electric entry, a utility electric meter or to an entry of an electric panel.

Electronic thermostat: a thermostat that controls one or several thermal loads by means of Pulse Width Modulated controlled signals.

Thermal load: electric device or apparatus for heating or cooling an area.

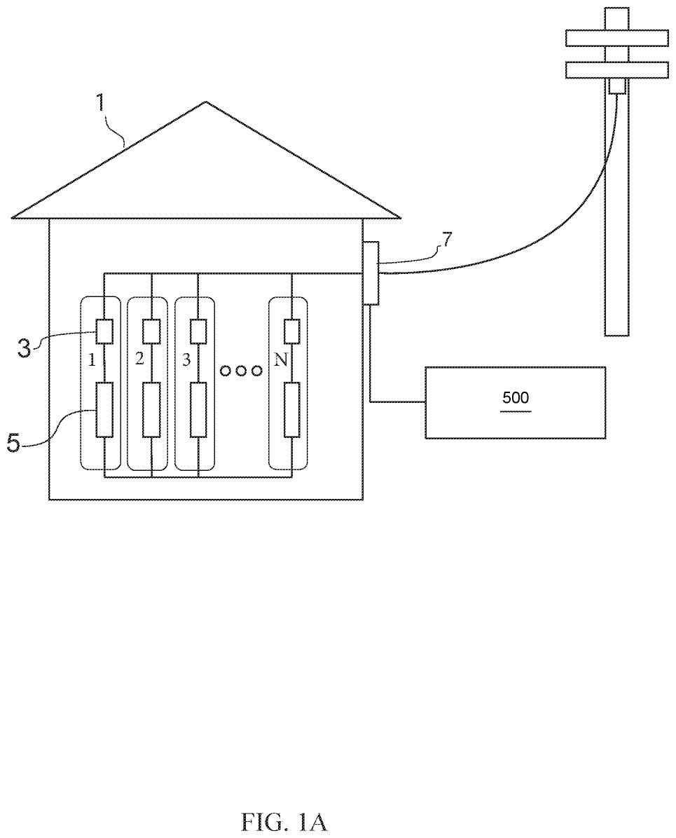

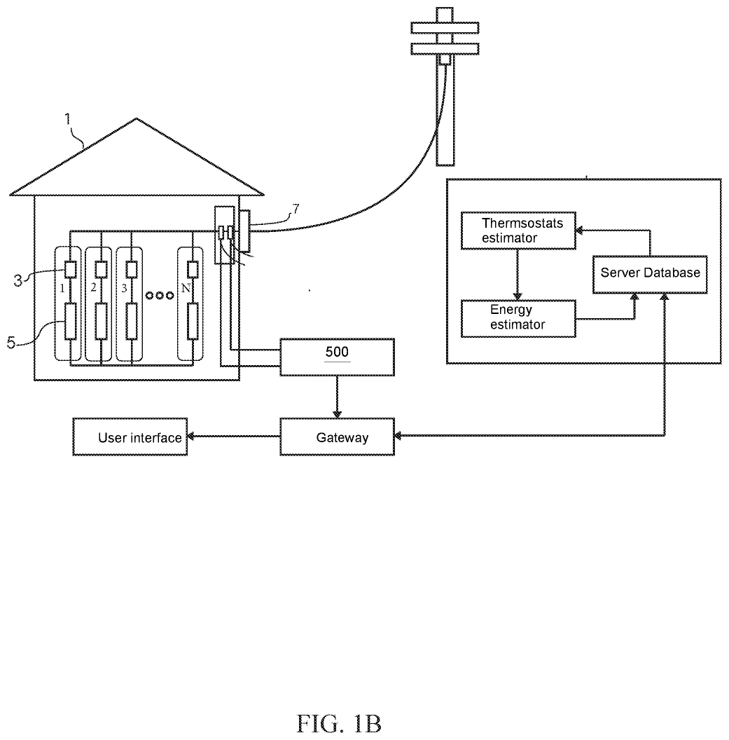

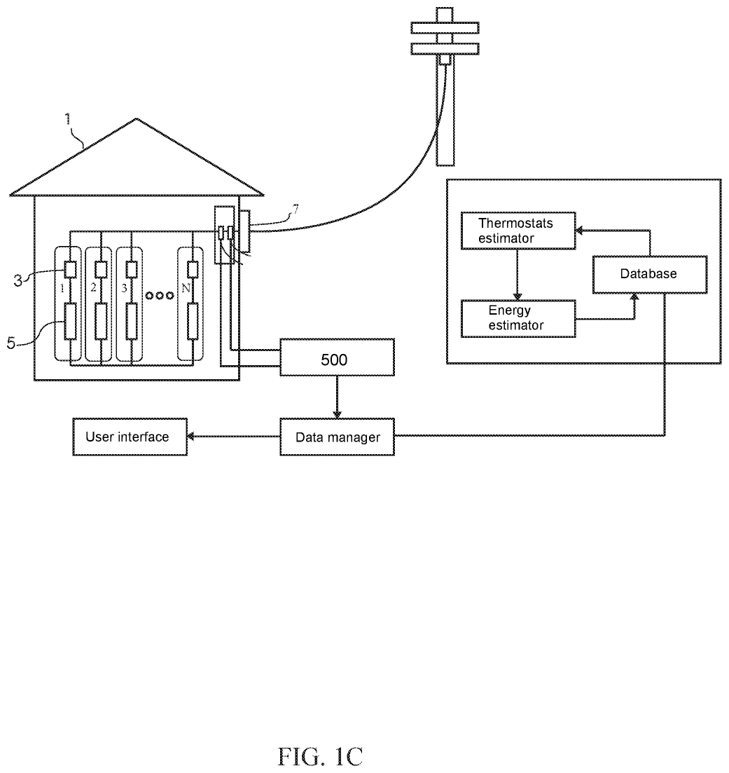

Reference is now made to FIGS. 1-3 concurrently. FIG. 1A is a simplified block diagram of an area 1 with a system for non-intrusively estimating a number of electronic thermostats in the area. Throughout the present specification, the term “area” is used to refer to an interior volume in which thermal loads are electrically powered to control comfort; “area” may correspond to any type of residential, commercial or industrial building such as for example an apartment, a condo, a house, an office, a store, etc.

The area 1 depicted for exemplary purposes is a house, in which N electronic thermostats 3 are installed, and each electronic thermostat 3 controls one or several baseboards or convectors. The area 1 is connected to the electric grid through an electric entry 7. The electric entry 7 is the entry point for the electricity consumed by the electric loads in the area 1. The electric loads are connected to the electric entry 7 through an electric panel (not shown for simplicity purposes). The electronic thermostat 3 and the baseboards or convectors are one type of electric loads in the area 1. The other electric loads are not shown, again for simplicity purposes. Throughout the present specification, the expression thermal load 5 is used to refer to any electric device or apparatus used for heating or cooling an area, such as for example baseboards and convectors.

Each electronic thermostat 3 controls a flow of electric energy to one or several thermal loads 5, by using Pulse-width Modulation (PWM), which is a modulation technique using a fixed commutation frequency or carrier frequency, e.g. frequency at which the pulses are generated for controlling the one or several thermal loads 5, such as for example activating and deactivating the one or several thermal loads 5. PWM is a technique used for controlling the energy flow to electrical loads which are characterized by a constant resistance, such as for example heating resistances or convectors 5. Typically, an area can include multiple electronic thermostats 3, each controlling the heating in a sub-area (such as for example a room) of the area. Installation of the electronic thermostats 3 is usually performed by an electrician during construction of the area 1, or during a subsequent renovation of the area 1. In a typical installation, all the electronic thermostats 3 in an area 1 are of the same type and same brand, thus having identical manufacturing parameters, e.g. using PWM with the same commutation frequency. As all electronic thermostats 3 in an area 1 share an identical behavior and their connected thermal loads have similar resistance, it becomes very difficult to non-intrusively evaluate the number of thermostats 3 in an area 1 and the number of thermal loads 5, especially as the number of electronic thermostats 3 in the area 1 increases.

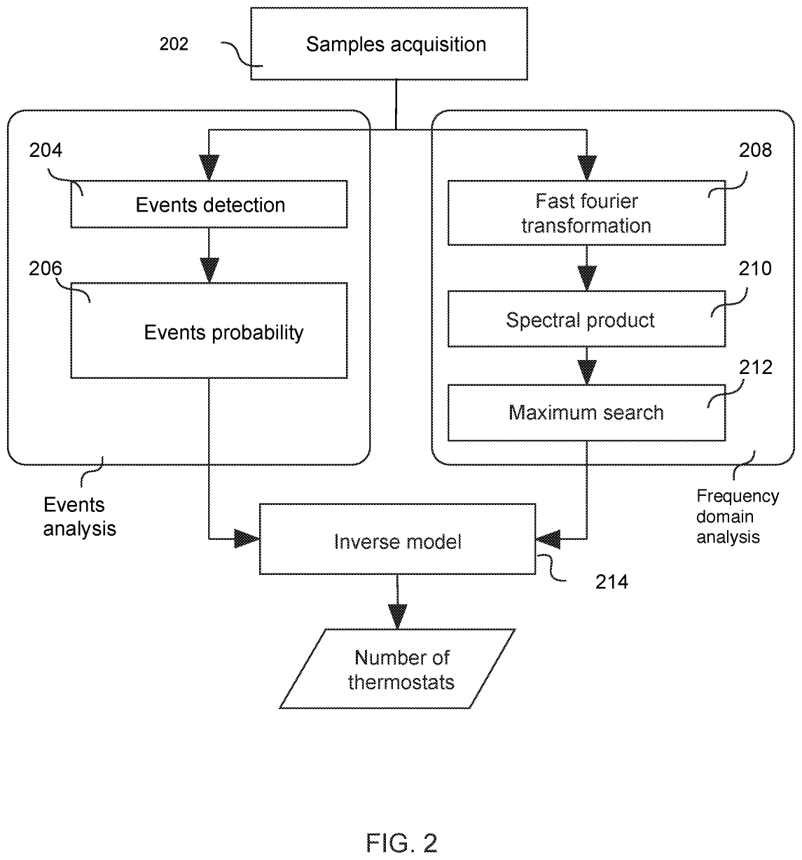

To overcome this problem, the present system and method rely on a combination of events analysis and frequency domain analysis. FIG. 2 is a functional block diagram of the present system and method for non-intrusively estimating a number of electronic thermostats 3 in an area 1.

The present system and method start by acquiring 202 a finite sequence of discrete samples of aggregated electric power consumed by the area 1. The finite sequence of discrete samples of aggregated electric power may be acquired using for example a clamp power detector, or a combination of clamp voltage detector and clamp current detector and inferring the power therefrom. The finite sequence of discrete samples of aggregated electric power are acquired at a sampling rate of at least ten times a commutation frequency of the electronic thermostats 3 and over a sampling duration T. For clarity purposes, the expression “sequence of discrete samples of aggregated electric power” acquired during over the sampling duration T are alternatively referred herein as a “finite sequence of samples”. In order to ensure reliable results with every type of electronic thermostats 3 available on the market, the sampling rate may for example be set to a value higher than 10 times the highest commutation frequency of available electronic thermostats. For example, for electronic thermostats having a commutation frequency of 1/16 hertz, the sampling frequency has to be set at a value higher than or equal to 10/16 hertz. Reliable results have been obtained with sample rates of 4 hertz. The sampling duration T is set to a value that ensures capturing several thermostat cycles. To provide reliable results, the events analysis relies on observing a number of events (e.g. power variations over a predetermined threshold) during the sampling duration T. Short sampling durations T results in a low number of thermostat cycles and consequently in a lower statistical confidence for reliable events analysis. Experimental results with commercial thermostats has shown adequate performance with a sampling duration T of at least 20 times a commutation period of the thermostat. So, for electronic thermostats with a commutation frequency of 1/16 hertz, the sampling duration T is set at (16*20=320 seconds). During experimentation, sufficient thermostat cycles were captured for thermostats having a period of commutation of 16 seconds with a sampling duration of 300 to 600 seconds. The present system and method are not limited to such values.

The finite sequence of samples is then processed in parallel for event analysis and frequency domain analysis. The samples of aggregated electric power consumed by the area 1 comprises the electric signature of the electronic thermostats 3, but also includes all electric variations caused by the other electric devices powered by the aggregated electric power for the area 1. The event analysis comprises events detection 204 and events probability 206. The event detection 204 computes a power magnitude difference between two consecutive discrete samples of aggregated electric power in the finite sequence. Further, the computed difference is tagged to be a valid event, if its values are above a predefined threshold. The predefined threshold is fixed to a smaller power variation which can be detected for a thermostat over the aggregated power profile. Electronic thermostats are connected to the baseboards or convectors, the nominal power of each baseboard can change according to the dimension of the sub-area where it is installed. However, smaller baseboards have a typical power of around 250 watts, then a predefined threshold of 20% of the lowest measurable typical power is considered enough for detecting the smaller power variations. In experimental works, the predefined threshold was established at 50 Watts, which was sufficient to determine reliably the number of electronic thermostats 3 in the area 1.

As each electronic thermostat controls its corresponding thermal load(s) by means of PWM at a fixed commutation frequency, it is possible to predict the probability of observing an event, e.g. a variation in the aggregated electric power consumed by the area, using the following equation:

$${P}_{e} = 2 \frac{{f}_{c}}{{f}_{e}} \qquad ( 1 )$$

where: Pₑ is a probability for observing an event, f_{c} is the sampling rate, and fₛ is the commutation frequency of the electronic thermostat.

The events probability is calculated using the following equation:

$${\hat{P}}_{e} ( k ) = {\hat{P}}_{e} ( k - 1 ) + \frac{Δ t}{T} ( δ ( Δ {x}_{k} ) - {\hat{P}}_{e} ( k - 1 ) ) \qquad ( 2 )$$

where:
Δt is the sampling rate in seconds;
T is the sampling duration in seconds;
δ(Δ xₖ) is 1 when an event is detected and 0 otherwise;
k is a time index of the sample; and
Pₑ(k) is the estimated events probability.

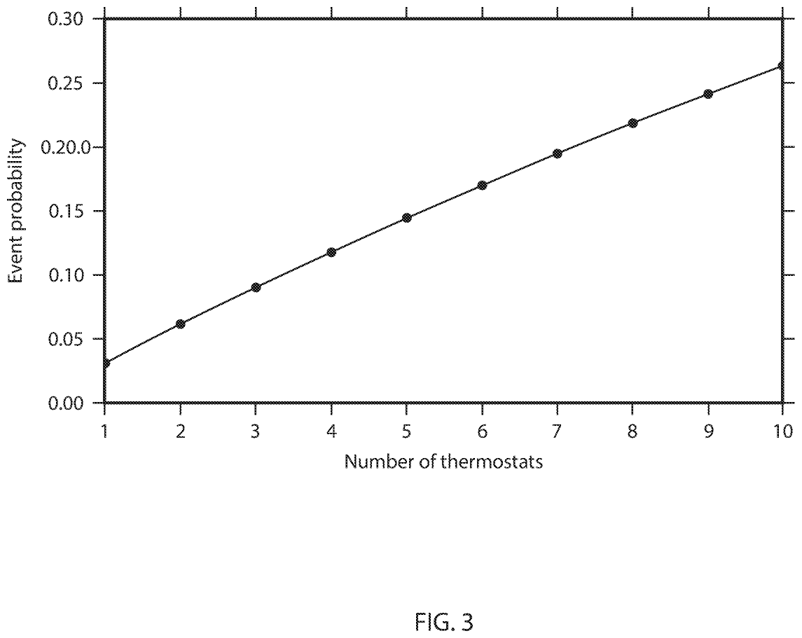

Reference is now concurrently made to FIG. 3, which is a graph depicting the relation between the events probability and the number of electronic thermostats 3. As can be appreciated, the events probability increases as the number of electronic thermostats 3 increases in the area 1.

Each of the multiple electronic thermostats 3 in the area are operating independently, e.g. there is no coordination amongst the electronic thermostats 3. Considering that the area 1 includes several electronic thermostats 3, the probability of detecting an event with multiple electronic thermostats can thus be compounded with the following equation:

$${P}_{e} ( N ) = 1 - {( 1 - 2 \frac{{f}_{c}}{{f}_{s}} )}^{N} - \frac{N ( N - 1 )}{2} {( \frac{{f}_{c}}{{f}_{s}} )}^{2} {( 1 - \frac{{f}_{c}}{{f}_{s}} )}^{N - 2} \qquad ( 3 )$$

Equation (2) correlates the constant parameters of the electronic thermostats, e.g. their commutation frequency, to the sampling rate of the present system and method, for the N electronic thermostats in the area 1. Resolving equation (2) provides an estimation of the number of electronic thermostats 3 in the area 1. However, as the commutation frequency of the electronic thermostats 3 is not known, the frequency domain analysis is concurrently performed to determine the commutation frequency of the electronic thermostats 3.

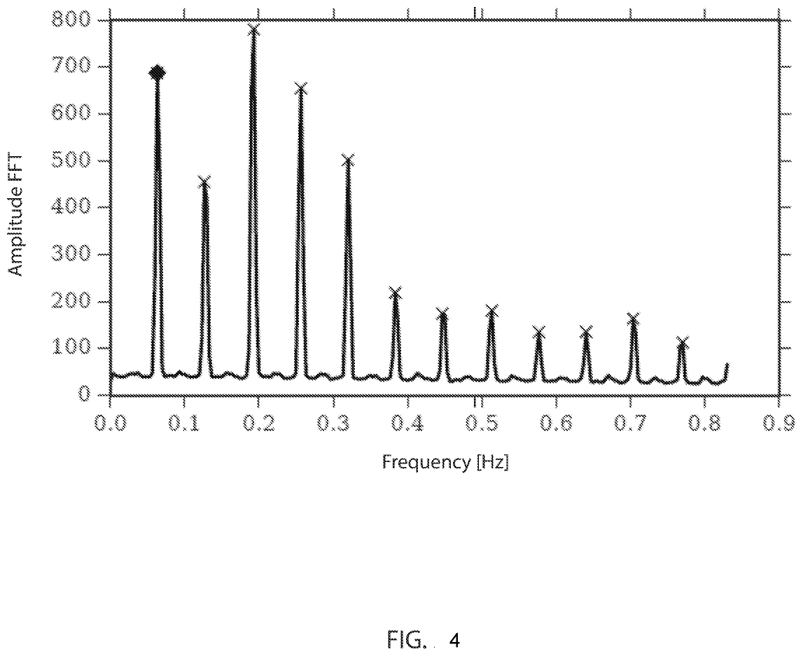

The frequency domain analysis is performed in parallel to the events detection 204 and events probability 206. The frequency domain analysis comprises performing a Discrete Fourier transform 208 over a finite sequence of discrete samples of aggregated electric power consumed by the area 1. The Discrete Fourier transform extracts frequency information presented in each finite sequence of discrete samples of aggregated electric power. An example of frequency domain information extracted for a finite sequence of samples of aggregated electric power consumed in an area 1 including ten electronic thermostats 3 is provided in FIG. 4. More particularly, the frequency information shown on FIG. 4 comprises a series of impulsions corresponding to a carrier frequency and harmonics. In FIG. 4, the first impulsion, also called fundamental frequency, corresponds to the commutation frequency of the electronic thermostats, the subsequent impulsions correspond to harmonics of the fundamental frequency and are integer multiple of the fundamental frequency.

In theory, the fundamental frequency is extracted by finding the first impulsion in the frequency domain information. However, amplitude of frequency components can be perturbed by other loads concurrently powered by the aggregated power. It is therefore not possible to rely solely on the detection of the first impulsion to determine the commutation frequency of the electronic thermostats 3. To overcome this problem, and to reliably identify the commutation frequency of the electronic thermostats, a method of spectral product 210, also known as Harmonic Product Spectrum (HPS) is performed. HPS is based on multiplying frequency components 210, the frequency information being either original, compressed or filtered. With HPS, it becomes possible to more accurately identify the commutation frequency of the electronic thermostats 3, as the commutation frequency corresponds to the impulsion with the maximum amplitude value and identifying the impulsion with maximum amplitude 212 provides the commutation frequency of the electronic thermostats 3. HPS is an appropriate method for identifying the commutation frequency of the electronic thermostats 3, as heating is an important part of the electricity consumed in cold climates, during heating season the thermostats have a major impact on the frequency information. Although HPS is used in the present example, the present system and method are not limited to this technique for extracting the commutation frequency of the electronic thermostats 3 from the samples of aggregated electric power consumed by the area 1.

Once the estimated events probability Pₑ(k) and the commutation frequency of the electronic thermostats 3 are calculated, it then becomes possible to reliably estimate the number of electronic thermostats 3 in the area 1 by applying an inverse model 214.

The inverse model 214 may comprise an approximation analysis, or a numeric approach using the following equation:

$$\hat{N} = {arg max}_{N ∈ \{ 0 , 1 , … , {N}_{max} \}} {( {P}_{e} ( N ) - {\hat{P}}_{e} ( k ) )}^{2} \qquad ( 4 )$$

where:—Nₘₐₓ is the maximum possible number of electronic thermostats operating in the area 1 during the sample k.

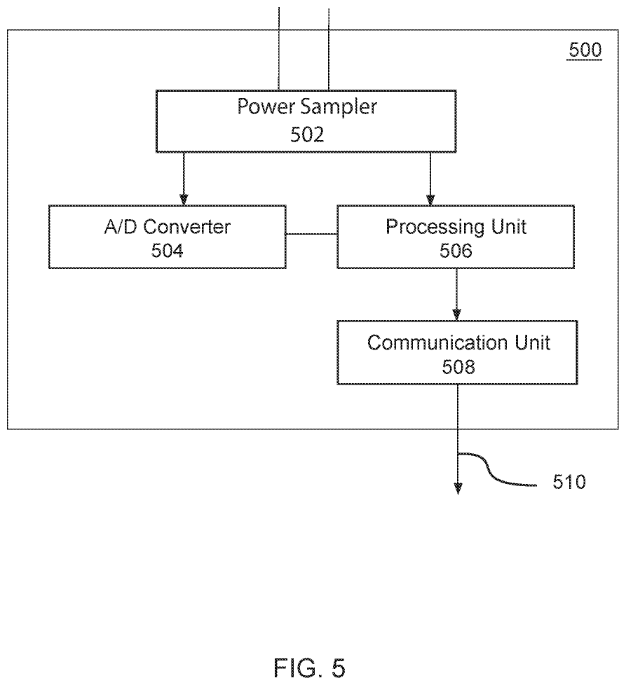

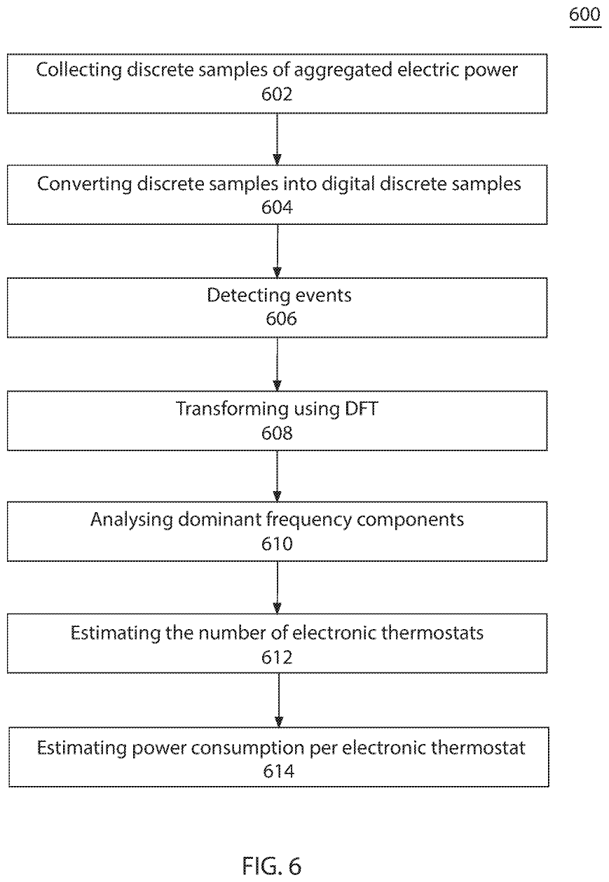

Reference is now made concurrently to FIGS. 5 and 6, where FIG. 5 is a block diagram of the system 500 for non-intrusively estimating the number of electronic thermostats 3 in the area 1, and FIG. 6 is a flow diagram of the corresponding method.

The system 500 comprises a power sampler 502 for collecting 602 a finite sequence of discrete samples of aggregated electric power consumed by the area 1. The power sampler 502 may be an off-the-shelf power meter, or a dedicated electric apparatus or custom power sampler. The power sampler 502 collects the discrete samples of aggregated electric power at a predefined sampling rate. The sampling rate may be a fixed value, or depending on the requirements on the system 500, could be a predefined sampling rate which could be modified by a control message received from a manufacturer or a utility provider. In a particular example, sampling rate is set at a minimum rate of 1 Hz.

The system 500 further comprises an analog/digital converter 504 for converting 604 the discrete samples of aggregated electric power into discrete-time samples.

The system 500 further comprises a processing unit 506. The processing unit 506 may comprise a field-programmable gate array (FPGA), a digital signal processor, one or several processors and/or a remote virtual machine executed locally as shown on FIG. 1A, or remotely such as for example in a data center as shown on FIGS. 1B and 1C. The processing unit 506 performs the events analysis. More particularly, the processing unit 506 receives the discrete-time samples, detects 606 events therein based on a comparison between a power magnitude variation and a defined power threshold, and counts 608 the events in the discrete-time samples of each sampling duration T.

The processing unit 506 further converts 608 the finite sequence of discrete-time samples into a discrete-frequency representation using a Discrete Fourier Transform (DFT) to identify dominant frequency components and analyze the dominant frequency components to estimate the commutating frequency. The estimated commutating frequency corresponds to a most likely commutating frequency of the electronic thermostats.

The processing unit 506 further transforms 608 each discrete sample using a Discrete Fourier Transform to extract 610 frequency information. The processing unit 506 then analyzes 612 the extracted frequency information to identify a commutation frequency of the electronic thermostats 3.

The processing unit 506 then estimates the number of electronic thermostats 3 in the area 1 based on the counted number of events (e.g. power variations above the predefined threshold), the sampling duration Tfor collecting the discrete samples of aggregated electric power, and the identified commutation frequency of the electronic thermostats.

The system 500 further comprises a communication unit 508 for outputting the estimated number of electronic thermostats in the area 1. The communication unit 508 may communicate with the utility provider, to inform the utility provider of the number of electronic thermostats 3 currently operating in the area 1. Alternately or concurrently, the communication unit 508 may communicate wirelessly with a comfort system of the area 1, so as to provide feedback as to the number of electronic thermostats 3 currently operating in the area 1. The comfort system (not shown) may store the information on the number of electronic thermostats 3 operating over time in the area 1, so as to provide an overview to the occupants of the area 1 of the period of operation of the electronic thermostats 3 and provide a more granular information on the electricity consumed.

In another option, the communication unit 508 communicates wirelessly with an application installed on an electronic device. The application may be adapted for reporting or sending an alert to the user of the electronic device when the number of electronic thermostats 3 operating is higher than a threshold set by the user of the application.

The processing unit 506 is further adapted for estimating for each one of the number of electronic thermostats 3 a consumed electric power from the aggregated electric power consumption. The processing unit further estimates a relative consumed electric power for each one of the number of electronic thermostats. Estimating individual thermostat power consumption is performed using a power disaggregation technique. The disaggregation consists of the overall power consumption separation in order to uncover individual power profiles. One appropriate technique for power disaggregation consists to construct a Factorial Hidden Markov Model (FHMM) as proposed by Kolter and Jaakkola in the published article “Approximate Inference in Additive Factorial HMMs with Application to Energy Disaggregation”. In this technique, each thermostat is modeled as discrete Markov process. The overall power consumption is a consequence of the parallel operation of a finite number of underlying loads. However, for performing conventional FHMM analysis the number of instances has to be provided. To address this problem, the processing unit 506 uses the estimated number of thermostats for constructing an adequate number of underlying processes. The FHMM method is used for detecting the thermostatic states. When individual states are established, the power consumption of each element is assigned according to nominal power of the baseboard, which is connected, to the thermostat.

The communication unit 508 outputs the estimated consumed electric power for each one of the number of electronic thermostats, or outputs the relative consumed electric power for each one of the number of electronic thermostats.

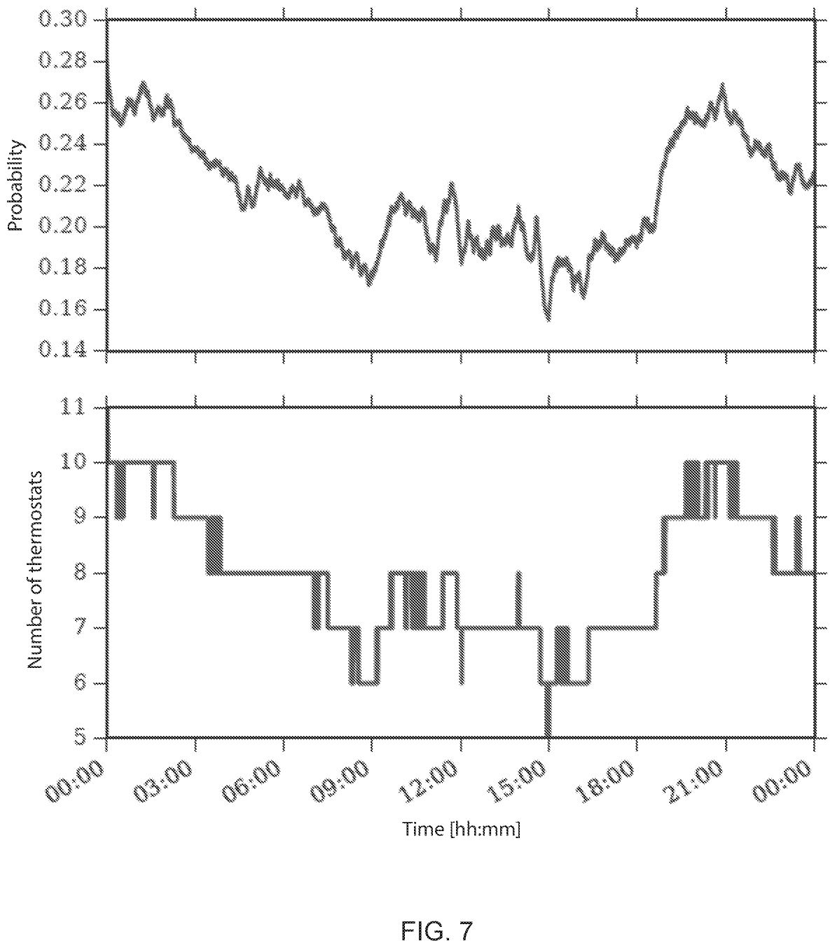

FIG. 7 shows two graphs resulting from an experiment performed to validate the present system and method, the upper graph depicting variations of events probability 206 over time and the lower graph shows a number of electronic thermostats in operation over the same period of time. Although both the upper graph and lower graph follow similar general variations, it can be appreciated that relying solely on the events probability 206 would not provide an accurate overview of the situation, thus the need for combining the events analysis with the frequency domain analysis herein described.

Reference is now concurrently made to FIGS. 1B and 1C which are simplified block diagrams of the area with other examples of implementation of the present system for non-intrusively estimating a number of electronic thermostats in the area. In the simplified block diagram of FIG. 1B, the present system communicates with a gateway, which forwards the estimated number of thermostats to a user interface. The gateway further provides the estimated number of thermostats to a remote utility provider, or to a cloud-based system, which collect the estimated number of thermostats currently active in the serviced electric network. In addition to providing the estimated number of thermostats to the gateway, the present system 500 may further provide the estimated consumed power by each thermostat. The gateway further forwards the estimated consumed power by each thermostat to the server database, so that the remote utility provider or the cloud-based system may compile the estimated consumed power as well. The estimated number of thermostats together with the estimated electricity consumed by each thermostat provides a more detailed assessment of the electric power consumption of each area 1 and assists in identifying sub-areas of the area 1 which are consuming more electric power than the other sub-areas.

FIG. 1C is a slightly modified block diagram of FIG. 1B, in which the present system 500 communicates the estimated number of thermostats to a data manager, which in turn provides the estimated number of thermostats to a user interface of the area 1, and to a database of a remote utility provider or cloud-based system, which collect the estimated number of thermostats currently active in the serviced electric network. In addition to providing the estimated number of thermostats to the data manager, the present system 500 may further provide the estimated consumed power by each thermostat. The data manager further forwards the estimated consumed power by each thermostat to the database, so that the remote utility provider or the cloud-based system may compile the estimated consumed power as well.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A system for non-intrusively estimating a number of electronic thermostats in an area, where each electronic thermostat controls at least one thermal load, the system comprising:
a power sampler for collecting, at an electric entry of the area, a finite sequence of discrete samples of aggregated electric power consumed by the area;
an analog/digital converter for converting the finite sequence of discrete samples of aggregated electric power into discrete-time samples;
a processing unit for converting the discrete-time samples into a discrete-frequency representation using a Discrete Fourier Transform, for extracting frequency information from the discrete-frequency representation and for analyzing the extracted frequency information to identify a commutation frequency of the electronic thermostats, the processing unit receiving the discrete-time samples and counting a number of power variations above a threshold in the discrete-time samples, the processing unit estimating the number of electronic thermostats in the area based on the number of power variations above the threshold in the discrete-time samples, a sampling duration for collecting the discrete samples of aggregated electric power, and the identified commutation frequency.

2. The system of claim 1, wherein the power sampler collects the discrete samples of aggregated electric power at a predefined sampling rate.

3. The system of claim 1, wherein the processing unit comprises one or several of the following: a field-programmable gate array (FPGA), a digital signal processor, one or several processors, a remote virtual machine executed in a data center.

4. The system of claim 1, further comprising a communication unit for outputting the estimated number of electronic thermostats in the area.

5. The system of claim 4, wherein the processing unit further estimates for each one of the number of electronic thermostats a consumed electric power, and the communication unit outputs the estimated consumed electric power for each one of the number of electronic thermostats.

6. The system of claim 4, wherein the processing unit further estimates a relative consumed electric power for each one of the number of electronic thermostats, and the communication unit outputs the relative consumed electric power for each one of the number of electronic thermostats.

7. The system of claim 1, wherein the power sampler collects the discrete samples of aggregated electric power at a minimum rate of 1 Hz.

8. The system of claim 1, wherein the extracted frequency information comprises frequency and amplitude for a series of impulses.

9. The system of claim 8, wherein the impulse having the higher amplitude is considered the commutation frequency.

10. The system of claim 1, wherein the threshold is at least 20% of a nominal power of a smaller baseboard in the area.

11. A method for non-intrusively estimating a number of electronic thermostats in an area, where each electronic thermostat controls at least one thermal load, the method comprising:
collecting, by a power sampler connected at an electric entry of the area, discrete samples of aggregated electric power consumed by the area;
converting by an analog/digital converter the discrete samples of aggregated electric power into discrete-time samples;
counting, by a processing unit, a number of power variations above a threshold in the discrete-time samples;
converting, by the processing unit, the discrete-time samples into a discrete-frequency representation using a Discrete Fourier Transform (DFT);
extracting, by the processing unit, frequency information of the discrete-frequency representation;
analyzing, by the processing unit, the frequency information to identify a commutation frequency of the electronic thermostats; and
estimating, by the processing unit, the number of electronic thermostats in the area based on the number of power variations above the threshold in the discrete-time samples, a sampling time for collecting the discrete samples of aggregated electric power, and the extracted commutation frequency.

12. The method of claim 11, wherein the collecting of the discrete samples of aggregated electric power is performed at a predefined sampling rate.

13. The method of claim 11, wherein the processing unit comprises one or several of the following: a field-programmable gate array (FPGA), a digital signal processor, one or several processors, a remote virtual machine executed in a data center.

14. The method of claim 11, further comprising outputting by a communication unit the estimated number of electronic thermostats in the area.

15. The method of claim 11, further comprising estimating by the processing unit a consumed electric power for each one of the number of electronic thermostats and outputting the estimated consumed electric power for each one of the number of electronic thermostats by the communication unit.

16. The method of claim 14, further comprising estimating by the processing unit a relative consumed electric power for each one of the number of electronic thermostats, and outputting by the communication unit the relative consumed electric power for each one of the number of electronic thermostats.

17. The method of claim 11, wherein collection of the discrete samples of aggregated electric power is performed at a minimum rate of 1 Hz.

18. The method of claim 11, the extracted frequency information comprises frequency and amplitude for a series of impulses.

19. The method of claim 18, the impulse having the higher amplitude is considered the commutation frequency.

20. The method of claim 11, wherein the threshold is at least 20% of a nominal power of a smaller baseboard in the area.
